(19) United States
(12) Patent Application Publication
(10) Pub. No.: US 2005/0119105 A1
(43) Pub. Date: Jun. 2, 2005

(54) Glass-ceramic composite containing nanoparticles

(75) Inventors: Jose Zimmer, Ingelheim (DE); Jorg Hinrich Fechner, Mainz (DE)

Correspondence Address: CHARLES N.J. RUGGIERO, ESQ.;OHLANDT, GREELEY, RUGGIERO & PERLE, L.L.P., 10th FLOOR, ONE LANDMARK SQUARE, STAMFORD, CT, 06901-2682, US

(73) Assignee: Schott AG

(21) Appl. No.: 10/890,682

(22) Filed: Jul. 14, 2004

Related U.S. Application Data
(63) Continuation of application No. PCT/EP02/14043, filed on Dec. 11, 2002.

(30) Foreign Application Priority Data
Jan. 18, 2002 (DE) 102 01 747.6

(51) Int. Cl. C03C 14/00; C03C 10/04; C03C 3/078

(52) U.S. Cl. 501/32; 65/17.3; 65/33.4; 65/33.8; 501/5; 501/72

(57) ABSTRACT

A composite material having a glass phases or glass ceramic phase is provided. The composite material includes nanoparticles and the glass phases is charged with nanoparticles on or in the surface.

The invention concerns an inorganic glass-ceramic composite material, comprising a glass or glass-ceramic phase as well as nanoparticles. The composite material is particularly characterized by its antimicrobial, inflammation-inhibiting, wound-healing and light-absorbing as well as light-scattering properties.

Glasses with a bioactive effect and also partially an antimicrobial effect are described as bioglass by L. L. Hensch, J. Wilson, An Introduction to Bioceramics, World Scientific Publ. 1993. Such bioglass is characterized by the formation of hydroxyappatite layers in aqueous media. Alkaline and alkaline-earth silicate glasses that are free of heavy metals and have antimicrobial properties are described in the applications WO 01/04252 and WO 01/03650.

DE 196 47,368 A1 shows composite materials containing a substrate and a nanocomposite standing in functional contact. The substrate can be comprised of glass material and be present in the form of powders. The nanocomposite can cover the substrate completely or partially as a coating.

A glass powder has become known from U.S. Pat. No. 5,676,720, which comprises 40-60 wt. % SiO₂, 5-30 wt. % Na₂O, 10-35 wt. % CaO, 0-12 wt. % P₂O₅, and a glass-ceramic material produced from a glass of such a composition has also become known.

U.S. Pat. No. 5,981,412 describes a bioactive bioceramic for medical applications with the crystalline phase Na₂O.2CaO.3SiO₂. The crystallite size lies at 13 μm. The ceramic is produced with tempering steps for seeding and crystalliztion. Emphasis lies on the mechanical properties, such as, e.g., K_{1c}. The proportion of crystal phase lies between 34 and 60 vol. %.

Nanoparticles such as, for example, TiO₂ or ZnO, with particle sizes of about 20-100 nm, are utilized for UV blocking in cosmetic and other products. The UV blocking is based on the absorption, reflection and scattering of radiation by means of these nanoparticles. UVB (290-320 mn) and UVA (320-400 mn) radiation is scattered more in this case than radiation in the visible region. The skin can be protected from sunburn with these in sunscreen products.

TiO₂, particularly in the crystalline form anatase is, of course, also photocatalytically active. Electron-hole pairs are generated by the absorption of photons, which pairs can react with molecules of the TiO₂ particle surface or the surroundings. In this way, among other things, radicals can form, which can have damaging effects on living organisms. In order to avoid such negative effects, in particular for cosmetic applications, TiO₂ nanoparticles are currently coated with SiO₂ or Al₂O₃. In particular, TiO₂ nanoparticles, if they get into human cells, may lead to damage of DNA. The skin does not represent a barrier for nanoparticles, since they can also penetrate through the skin. In order to minimize the damaging effect of nanoparticles, according to WO 99/60994, TiO₂ nanoparticles can be provided with trapping ions, which prevent a formation of radicals on the nanoparticle surface due to electron-hole trapping.

The object of the invention is to avoid the disadvantages of the prior art and to provide an inorganic material, which, in addition to antimicrobial, inflammation-inhibiting and skin-regenerating properties, also absorbs, reflects, and scatters light, in particular UV radiation, but also radiation in the visible region, wherein radical formation will be avoided under UV irradiation and a migration of nanoparticles in the body tissue can be prevented.

The object is solved by use of the ceramic-glass composite according to claim 1.

The ceramic-glass composite is comprised of different phases. These are a glass or glass-ceramic phase as well as nanocrystals. The nanocrystals are found in this case on or in the surface of the larger glass or glass-ceramic particles.

The nanopowders have particle sizes with d50 values of <500 nm, preferably <200 nm, and still more preferably <100 nm, and most preferably <50 nm. Here, of course, the primary particle size can lie at clearly lower values.

The glass or glass-ceramic phases, which contain these nanoparticles on or in the surface, are preferably present in powder form with particle sizes with d50 values of <100 μm, preferably <50 μm, still more preferably <10 μm.

Still more preferred are particle sizes of the glass powder of <5 μm, preferably <2 μm, in special cases <1 μm.

If a glass-ceramic powder is present, then the crystals of the glass ceramic have crystallite sizes (d50) of <10 μm, preferably <1 μm, particularly preferred <500 nm, preferably <100 nm, in special cases <50 nm.

The ceramic-glass composite material of the invention is characterized in that the nanoparticles are fixed solidly to the surface of larger glass particles. In this way, the nanoparticles can be covered by a glassy layer, which prevents or suppresses the facile reaction of nanoparticles with the atmosphere.

The chemical resistance of the glass or glass ceramics is preferably high enough that the glass does not completely dissolve in cosmetic formulations and the nanoparticles covered with glass thus remain coated.

The chemical composition of the glass brings about antimicrobial, inflammation-inhibiting and skin-caring properties.

In addition, the material can show a biocidal, or in any case a biostatic action against bacteria, fungi and viruses, but will be compatible with the skin and toxicologically harmless when in contact with humans.

For specific applications, special requirements are placed on the purity of the powder, so that the toxicological harmlessness of the glass powder is assured.

The loading due to heavy metals should be as small as possible for this. Maximum concentrations worth striving for in the field of cosmetic products are, for example, Pb<20 ppm, Cd<5 ppm, As<5 ppm, Sb<10 ppm, Hg<1 ppm, Ni<10 ppm.

Preferably, the glass or the initial glass of the glass ceramics has the following components:

SiO₂ as the network former between 30 and 70 wt. %. With lower concentrations, the tendency toward spontaneous crystallization increases greatly and the chemical resistance sharply decreases. At higher SiO₂ values, the crystallization stability can decrease and the processing temperature is clearly increased, so that the hot-forming properties are adversely affected. SiO₂ is also a component of the crystalline phases that form during ceramizing.

Na₂O is utilized as a flux in the melting of the glass. At concentrations of <5%, the melting behavior is negatively influenced. Sodium is a component of the phases that form in ceramizing. Sodium is emitted from the powder, among other things, by means of ion exchange in aqueous media.

K₂O acts as a flux in the melting of the glass. In addition, potassium is emitted in aqueous systems, among other things, by means of ion exchange.

The chemical resistance of the glass and thus the ion discharge in aqueous media is adjusted via the P₂O₅ content. The P₂O₅ content lies between 0 and 10 wt. %. With higher P₂O₅ values, the hydrolytic resistance of the glass ceramics is too small.

In order to improve the melting behavior, the glass can contain up to 5 wt. % B₂O₃.

The quantity of Al₂O₃ should be <15 wt. %, in order to assure a crystallization stability of the glass that is sufficient for production. For glasses of glass ceramics with reinforced antimicrobial and inflammation-inhibiting, skin-caring properties, Al₂O₃ should be <5 wt. % preferably <2 wt. %, particularly preferred <1 wt. %.

In order to enhance the antibacterial properties of the glass ceramics, antibacterially acting ions, such as, e.g., Ag, Au, I, Ce, Cu, Zn, can be contained in concentrations of <5 wt. %. The concentration of these ions is <5 wt. %, in particular <2 wt. % in total.

In addition, ions such as Ag, Cu, Au, Li can be contained as additives for adjusting the high-temperature conductivity of the melt and thus for improved melting behavior with HF melting processes.

Color-rendering ions such as, e.g., Fe, Co, V, Cu, Cr can be doped in a targeted manner individually or combined in a total concentration of <1 wt. %.

By introducing oxides, such as, for example, TiO₂ and CeO, which also act as absorbing materials in the UV region, into the basic glass, an effective blocking of the UV radiation can be achieved, whereby by addition of different contents, the UV edges can be adjusted in a defined manner. The concentration of these oxides lies in total at <5 wt. %, preferably <2 wt. %, still more preferably <1 wt. %.

The glass can contain ions such as Ce, Mn, Ag, Au, Cu, Zn, Fe, which can act as electron traps. In this way, a radical formation can be suppressed by the electron-hole pairs generated by TiO₂ with UV irradiation.

Specific ions thus can exercise a double function. First of all, they reinforce synergistically the antimicrobial effect and, in addition, they can also trap by redox reactions free electrons which could lead to radical formation. The concentration of elements lies at <2 wt. %, in particular <1 wt. %, particularly preferred <0.1 wt. %.

The glass is melted by conventional melting technologies or by high-frequency processes and shaped into block glass or so-called “ribbons”. The glass or the initial glass of the glass ceramics can be pulverized into powder in a preferred embodiment. The particle size of this powder is preferably <100 μm, particularly preferred <50 μm, in particular <10 μm, in particular <5 μm, particularly <1 μm. Both dry as well as “wet” pulverizing technologies can be employed for this purpose. In the case of “wet” pulverizings, the powders can subsequently be dried.

In a second step, the glass powders can be mixed with the nanopowders. This can be done dry or the nanopowders are added as a dispersion to the dry or “wet” glass powders. An alternative production route consists of adding the nanoparticles to the glass even in the first pulverizing process.

After the mixing process, the nanoparticles are found on the surface of the glass powder. If the nanopowders were added in dispersion form, a drying may be necessary. The mixture is sintered in the oven. In this way, the nanopowders are combined with the glass powders. The nanoparticles are coated with glass during the sintering due to the surface diffusion processes. In this way, the nanoparticles are encapsulated against the environment. The chemical resistance of this glass encapsulation is high enough that a surface reaction of the TiO₂ with the environment is suppressed in cosmetic formulations.

The sintering temperatures for viscous sintering lie above the T_{g} of the initial glass, and in fact, preferably more than 0° C. to 500° C. above the T_{g}, particularly preferred more than 20° C. to 200° C. above the T_{g}, in particular, preferably more than 50° C. to 100° C., above the T_{g}.

In addition, the sintering can also take place below the T_{g}, and this is denoted so-called diffusion-controlled solid-state sintering. The temperatures here preferably lie at 200° C. to 0° C. below the T_{g}, in particular 100° C. to 10° C. below the T_{g}. The pulverizing time as well as the energy used can be reduced by this low-temperature sintering.

Depending on the type of glass each time, sufficiently high temperatures bring about a ceramizing of the glass. In this way, among others, alkaline/alkaline-earth silicates such as, for example, sodium-calcium silicates, and alkaline-earth silicates such as, for example, calcium silicate can be formed as the primary phases.

The sintering can also be conducted in a multi-stage temperature-time program in order to carry out, for example, in a targeted manner, a melting of the nanoparticles with the glass and thus a ceramizing of the glass that is controlled as much as possible by this.

Depending on the temperature sequence each time, a different degree of melting and of encapsulation of the nanoparticles with the glass surface can be achieved.

After the sintering process, the powders are pulverized once more for adjusting the final particle size.

The sintering process can be conducted in such a way that the glass phase is processed to ceramics. By ceramizing the basic glass with defined crystallite size, additional scattering or reflection effects can be established. Here, the effects can be controlled by process parameters such as, for example, by the temperature-time profile of the process, but also by the added quantity of crystal former.

The composite material is usually used as a powder, whereby particle sizes of <100 μm will be attained by a final pulverizing process. Particle sizes of <50 μm or <20 μm have proven to be appropriate. Particularly suitable are particle sizes of <10 μm as well as less than 5 μm. Particle sizes of <1 μm have turned out to be most particularly suitable. The pulverizing process can be conducted dry as well as with aqueous and non-aqueous pulverizing media.

The total quantity of nanoparticles in the composite material lies at <20 wt. %, preferably <10 wt. %, still more preferably <5 wt. %.

The light-influencing effects are achieved, first of all, by the nanoparticles, which intrinsically lead to absorption and scattering of the light, and secondly, by the surface morphology of the glass or glass-ceramic particles, which leads to a scattering of the light as well as by the bulk characteristics of the glass or glass-ceramic particles.

The nanoparticles that have been sintered in can simultaneously act as heterogeneous seeds for the crystallization of the glass phase. Thus the crystallization can be influenced by the nanoparticles.

The combination of nanoparticles with biologically active glass leads to a UV blocker with positive skin properties. The disadvantages of the nanoparticles are not just compensated for; rather there is over-compensation.

In addition, the coating of the glass particles with nanopowders leads to additional light-scattering effects, which are not observed for pure glass or glass-ceramic powders and can be attributed to the modified surface morphology.

The powders are excellently suitable for use in the field of cosmetic products. These can include, among others, products in the field of coloring cosmetics or UV protection products.

Other fields of application lie, for example, in the field of light protection, in the field of dyes and paints as well as in medicinal products and in the field of polymers.

By way of example, the invention will be described below on the basis of the embodiment examples and the figures. Here:

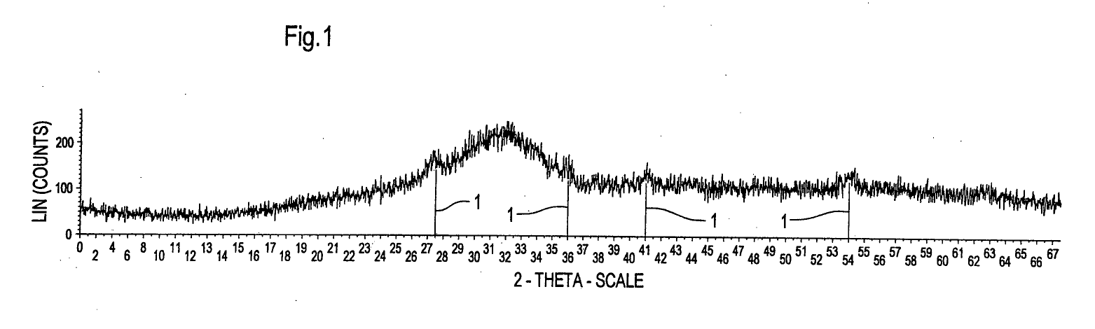

FIG. 1 shows a wide-angle x-ray diffraction pattern of a sample with a basic glass according to embodiment example 1 as well as TiO₂ (rutile) nanoparticles sintered thereon.

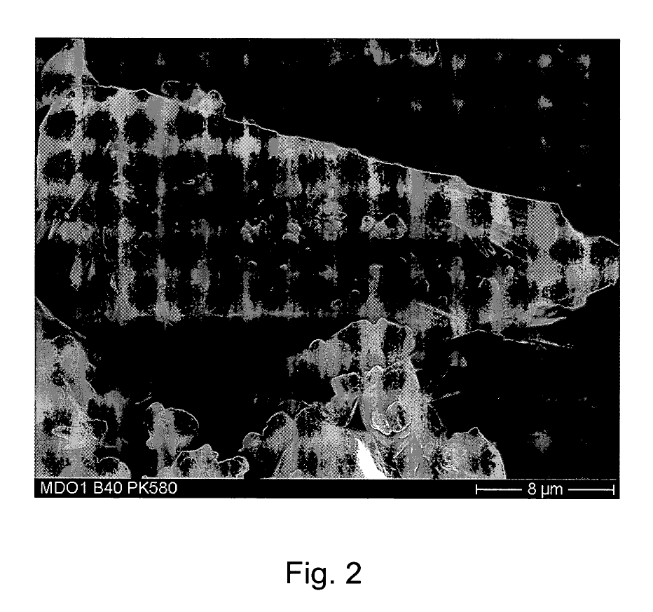

FIG. 2 shows an SEM micrograph of a basic glass according to embodiment example 1 without TiO₂ nanoparticles sintered thereon.

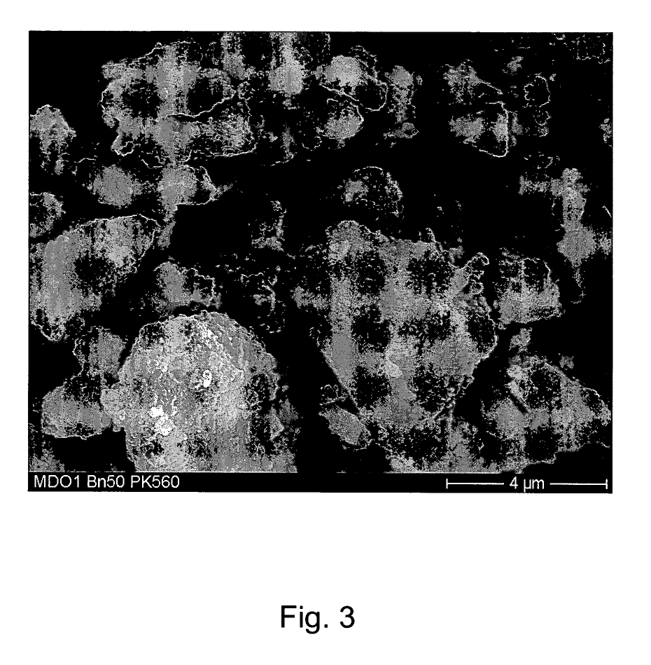

FIGS. 3-5 show SEM micrographs of a basic glass according to embodiment example 1 with 5 wt. % TiO₂ nanoparticles sintered thereon at 560° C. for one hour.

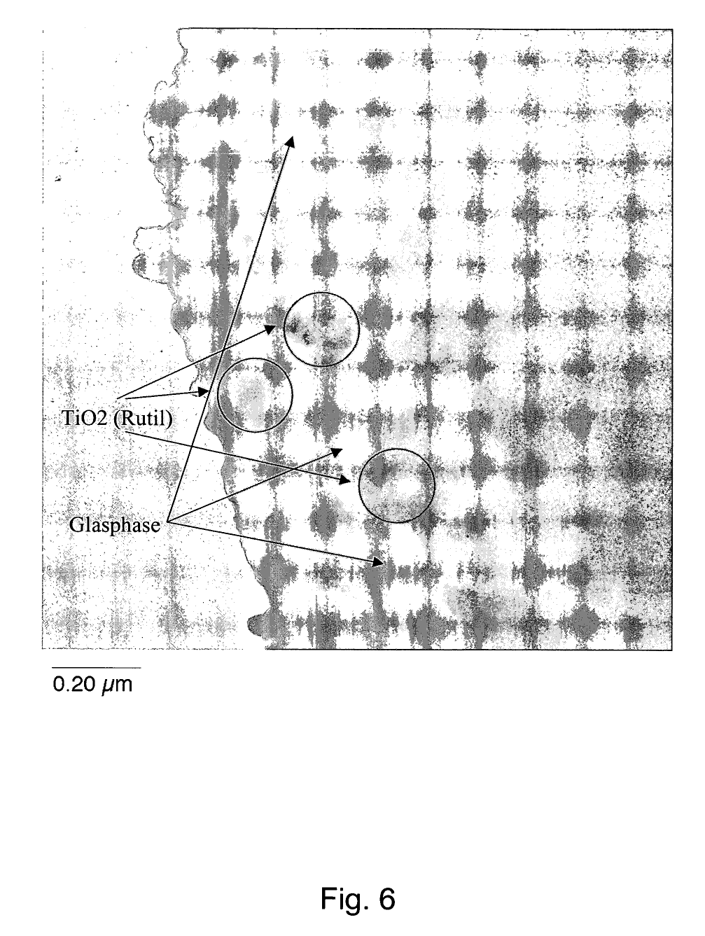

FIG. 6 shows a TEM micrograph of a basic glass according to embodiment example 1 with 5 wt. % TiO₂ nanoparticles sintered thereon at 560° C. for one hour.

First of all, a basic glass is melted from the raw materials indicated in Table 1, and this glass was then shaped into glass strips which are also denoted ribbons. These ribbons were further processed by means of dry pulverizing into powder with a particle size of d50=4 μm.

TABLE 1
Compositions in wt. % of the basic glasses

| Type | 1 | 2 | 3 | 4 | 5 | 6 | 7 | 8 |
|---|---|---|---|---|---|---|---|---|
| SiO₂ | 43.0 | 35 | 44.0 | 64 | 45.0 | 71.2 | 44.9 | 55.0 |
| Al₂O₃ | — | — | — | 3 | 4 | 0.35 | — | — |
| CaO | 25 | 25 | 24.5 | 15 | 20 | 9.6 | 24.5 | 19.5 |
| MgO | — | — | — | 1 | — | 4.0 | — | — |
| Na₂O | 25 | 25 | 24.5 | 15 | 24 | 14.1 | 24.5 | 19.5 |
| K₂O | — | — | — | 2 | 0 | 0.05 | — | — |
| P₂O₅ | 7.0 | 6.0 | 6.0 | — | 6.0 | — | 6.0 | 5.9 |
| B₂O₃ | — | 0 | 1.0 | — | 1.0 | — | — | — |
| Fe₂O₃ | — | — | — | — | — | 0.1 | — | — |
| MnO | — | — | — | — | — | — | — | 0.1 |
| AgO | — | — | — | — | — | — | 0.1 | — |

The 4 μm glass powder of type 1 was mixed dry in a drum pulverizer with 5 wt. % TiO₂ nanopowder with a secondary particle size of approximately 100 nm.

The powder mixture was then sintered in a box furnace at 580° C. for 2 hours. The sintered powder was subsequently briefly pulverized again in a drum pulverizer, so that a particle size of about 5 μm was established.

Under these sintering conditions, crystalline secondary phases with an essential phase fraction still cannot be detected by means of an x-ray diffraction pattern.

The nanopowders are sintered solidly into the surface of the glass powder and are for the most part completely coated with a glassy phase. This could be detected on the basis of both SEM and TEM.

The antimicrobial effect of the powder was tested according to the European Pharmacopoeia (3rd edition) and is reproduced in Table 2.

TABLE 2
Antimicrobial effect

| | | P. | | | |
|---|---|---|---|---|---|
| | E. coli | aeruginosa | S. aureaus | C. albicans | A. niger |
| Start | 250,000 | 280,000 | 240,000 | 310,000 | 230,000 |
| 2 days | 700 | 1,100 | 900 | <100 | 1,800 |
| 7 days | <100 | 200 | <100 | 0 | 1,000 |
| 14 days | 0 | 0 | 0 | 0 | 0 |
| 21 days | 0 | 0 | 0 | 0 | 0 |
| 28 days | 0 | 0 | 0 | 0 | 0 |

Skin compatibility tests were conducted for a DAC cream formulation containing 5 wt. % and 10 wt. %. No skin irritations could be observed.

FIG. 1 shows an x-ray diagram of a basic glass according to embodiment example 1 with TiO₂ (rutile) nanoparticles sintered thereon. The sintering was conducted at 560° C. for one hour. The amorphous structure of the basic glass as well as the crystalline structure of the sintered-on TiO₂ particles can be clearly recognized from the x-ray diffraction pattern. The x-ray reflexes of the sintered-on TiO₂ particles are denoted by the reference number 1.

FIG. 2 shows an SEM micrograph of a basic glass according to embodiment example 1 without sintered-on nanoparticles. The glass powder was sintered at 560° C. for one hour. A smooth surface without sintered-on nanoparticles can be recognized.

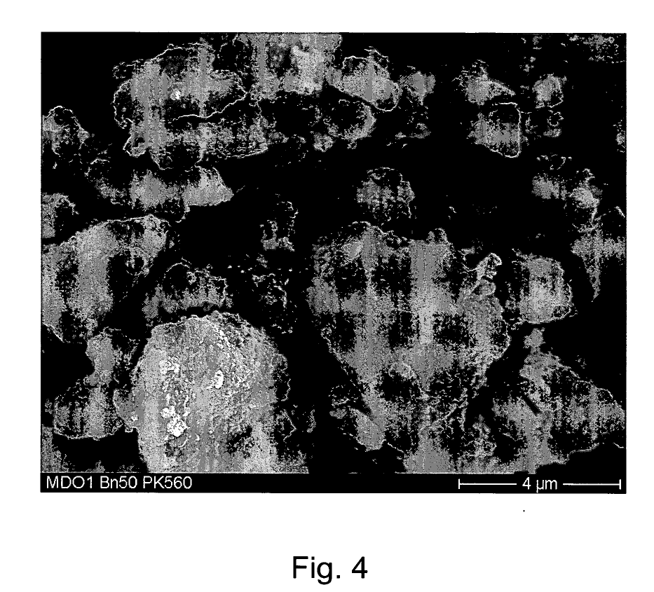

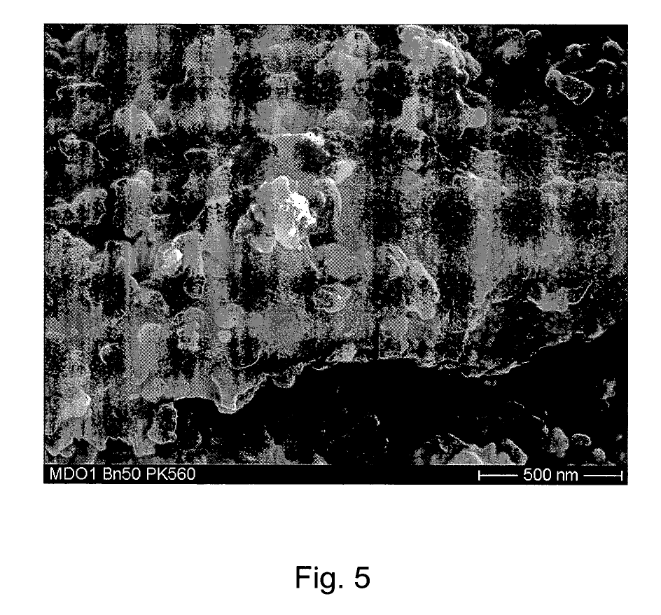

FIGS. 3-5 show a basic glass according to embodiment example 1 with 5 wt. % TiO₂ nanoparticles (rutile). This composition was sintered at 560° C. for one hour just like the comparative sample, whose surface is shown in FIG. 2. In contrast to the comparative sample shown in FIG. 2, the surface is not very smooth. The solid composite system between the individual nanoparticles, in the present case the rutile particles, and the basic glass powder, can be clearly recognized in FIG. 3 The solid composite system between the nanoparticles and the basic glass powder can also be very well recognized in FIGS. 4 and 5. The sample composition involves the same sample as in the SEM micrograph according to FIG. 3.

FIG. 6 shows a transmission electron microscope (TEM) micrograph of a basic glass according to embodiment example 1 with 5 wt. % TiO₂ nanoparticles sintered thereon at 560° C. for one hour. It can be recognized from this TEM micrograph that the TiO₂ (rutile) nanoparticle denoted by the reference number 10 is surrounded by a glassy phase, which is denoted by the reference number 20.

The antimicrobial, inflammation-inhibiting, UV radiation-reducing, glass-ceramic composite materials can be utilized in powder form preferably as an additive in the cosmetic industry, for example, in sunscreen creams and vanishing creams as well as creams for preventing skin aging.

The invention makes available for the first time a material in which different properties are combined in one material. By covering the TiO₂ with an antimicrobial, inflammation-inhibiting and skin-regenerating layer, a protection against radical formation is attained. This is achieved particularly due to the fact that the nanoparticles are bound to glass and thus no skin penetration can occur. In powder form, the material has special light-scattering, absorbing and reflecting properties based on the surface modification.

1. A composite material, comprising:
a glass or glass-ceramic phase having
SiO₂ 30 to 80 weight percent,
Na₂O 5 to 40 weight percent,
K₂O 0 to 40 weight percent,
Li₂O 0 to 40 weight percent,
CaO 5 to 40 weight percent,
MgO 0 to 40 weight percent,
Al₂O₃ 0 to 15 weight percent,
P₂O₅ 0 to 20 weight percent,
B₂O₃ 0 to 20 weight percent,
TiO₂ 0 to 5 weight percent, and
ZnO 0 to 5 weight percent; and
a plurality of nanoparticles, wherein said glass or glass-ceramic phase is occupied on and/or in the surface by said plurality of nanoparticles.

2. The composite material according to claim 1, wherein said TiO₂ comprises 0.1 to 5 weight percent.

3. A composite material, comprising:
a glass or glass-ceramic phase having
SiO₂ 30 to 80 weight percent,
Na₂O 5 to 40 weight percent,
K₂O 0 to 40 weight percent,
Li₂O 0 to 40 weight percent,
CaO 5 to 40 weight percent,
MgO 0 to 40 weight percent,
Al₂O₃ 0 to 15 weight percent,
P₂O₅ 2 to 20 weight percent,
B₂O₃ 0 to 20 weight percent, and
TiO₂ 0 to 5 weight percent; and
a plurality of nanoparticles, wherein said glass or glass-ceramic phase is occupied on and/or in the surface by said plurality of nanoparticles.

4. The composite material according to claim 3, wherein said glass or glass-ceramic phase comprises
SiO₂ 35 to 60 weight percent,
Na₂O 5 to 30 weight percent,
K₂O 0 to 20 weight percent,
CaO 5 to 30 weight percent,
MgO 0 to 10 weight percent,
Al₂O₃ 0 to 5 weight percent,
P₂O₅ 2 to 10 weight percent, and
B₂O₃ 0 to 5 weight percent.

5. The composite material according to claim 1, wherein said plurality of nanoparticles are titanium oxide nanoparticles.

6. The composite material according to claim 1, wherein said plurality of nanoparticles are zinc oxide nanoparticles.

7. The composite material according to claim 1, wherein an amount of said plurality of nanoparticles is less than 20 percent weight.

8. The composite material according to claim 1, wherein said plurality of nanoparticles are coated with said glass or glass-ceramic phase.

9. The composite material according to claim 1, wherein said glass or glass-ceramic phase comprises electron-hole trapping ions selected from the group consisting of Ce, Fe, Mn, Ag, and Au, said electron-hole trapping ions having a concentration of less than 5 weight percent.

10. The composite material according to claim 1, further comprising antibacterial ions selected from the group consisting of Ag, Au, I, Ce, Cu, and Zn, said antibacterial ions having mass proportions of less than 5 weight percent.

11. The composite material according to claim 1, wherein said glass or glass-ceramic phase is a powder having a particle size of less than 100 μm.

12. The composite material according to claim 11, wherein said particle size is less than 10 μm.

13. The composite material according to claim 11, wherein said particle size is less than 1 μm.

14. A method for the production of a composite material, comprising:
pulverizing a glass into a powder, wherein said glass includes SiO₂ 30 to 80 weight percent, Na₂O 5 to 40 weight percent, K₂O 0 to 40 weight percent, Li₂O 0 to 40 weight percent, CaO 5 to 40 weight percent, MgO 0 to 40 weight percent, Al₂O₃ 0 to 15 weight percent, P₂O₅ 0 to 20 weight percent, B₂O₃ 0 to 20 weight percent, TiO₂ 0 to 5 weight percent, and ZnO 0 to 5 weight percent;
mixing said powder with a plurality of nanoparticles to form a mixiture; and
sintering said mixture into an inorganic composite material.

15. The method according to claim 14, wherein pulverizing said glass and mixing said plurality of nanoparticles occur in the same process step.

16. The method according to claim 15, wherein said sintering occurs at a temperature between 20° C. to 500° C., above the glass transition temperature of said glass.

17. The composite material according claim 1, wherein the composite material is usable in a cosmetic product to protect the skin from harmful UV radiation.

18. The composite material according to claim 17, wherein the composite material imparts said cosmetic product with antimicrobial, inflammation-inhibiting and wound-healing, skin-caring effects.

19. The composite material according to claim 1, wherein the composite material is usable to impart antimicrobial and UV-protecting effects to dyes and paints.

20. The composite material according to claim 1, wherein the composite material is usable in a medicinal product to provide an effect selected from the group consisting of antimicrobial, inflammation-inhibiting, wound-healing, skin-caring and UV-blocking.

21. The composite material according to claim 1, wherein the composite material is usable in a plastic or polymer to provide an effect selected from the group consisting of antimicrobial, inflammation-inhibiting, wound-healing and UV-blocking.
